(19) United States
(12) Patent Application Publication
(10) Pub. No.: US 2013/0151434 A1
(43) Pub. Date: Jun. 13, 2013

(54) METHOD AND APPARATUS FOR TRACKING PACKAGE DELIVERIES

(71) Applicant: KITARU INNOVATIONS INC., Lascelles (BB)

(72) Inventor: Kapoor Chandaria, Nairobi (KE)

(73) Assignee: KITARU INNOVATIONS INC., Lascelles (BB)

(21) Appl. No.: 13/760,158

(22) Filed: Feb. 6, 2013

Related U.S. Application Data
(63) Continuation-in-part of application No. 13/285,295, filed on Oct. 31, 2011.
(60) Provisional application No. 61/494,556, filed on Jun. 8, 2011.

(51) Int. Cl. G06Q 10/08; G06Q 50/28

(52) U.S. Cl. CPC G06Q 10/08; G06Q 50/28
USPC 705/333

(57) ABSTRACT

A system and method for verifying receipt of a postal mail item mailed by a sender of the postal mail item is presented. Method detects whether a conductive material inside the parcel has been opened or not. The conductive material is a trace routed around the mail item in a way that makes it extremely difficult to open the mail item without breaking the conductive material. With an electronic device external to the parcel, the method energizes a communication device located in the parcel. Upon the communication device becoming energized, the method transmits from the communication device to the electronic device external to the parcel a signal that identifies if the conductive material in the parcel has been opened or not.

### CROSS-REFERENCE TO RELATED APPLICATION

This application is a continuation-in-part (CIP) application of U.S. patent application Ser. No. 13/285,295 that was filed Oct. 31, 2011 which claims priority from U.S. Provisional Patent Application Ser. No. 61/494,556, filed Jun. 8, 2011, the disclosure of which is incorporated herein by reference.

### BACKGROUND OF THE INVENTION

1. Field of Invention

The current invention relates generally to apparatus, systems and methods for processing mail. More particularly, the apparatus, systems and methods relate to determining when mail has been delivered. Specifically, the apparatus, systems and methods provide for determining when a specific addressee receives a particular letter or package.

2. Description of Related Art

The physical delivery of packages or envelopes through traditional means (traditional government postal service, courier or similar legacy delivery methods) can be fraught with issues and subject to fraud or misuse. This issue is particularly serious when related to the delivery of critical information, sensitive documents, financial instruments, credit cards, or documents with personally identifiable information (PII), such as driver licenses, passports, permits, etc. Packages, letters and missives carried by conventional postal delivery services or courier services rely on labor intensive methods to ensure parcels or letters are delivered to the intended recipient.

While the identity of the individual receiving or picking up a parcel or envelope can be established by traditional means (i.e. using proof of identity, such as a driver's license at the point of delivery or pickup), this is often time and labor intensive and is an error prone method, and furthermore, it cannot establish when the package was actually opened or by whom. Establishing when a package was actually opened is nearly impossible using traditional methods.

When packages or envelopes go missing, either due to intentional or unintentional actions, the process of tracking and tracing, and establishing the actual location of such items is very time consuming and a cause of customer dissatisfaction. When items are stolen, intentionally delayed or hidden from view, it is virtually impossible to determine the location, routing or chain of custody for such items.

In addition, the collection of critical information to permit process analysis, performance, establish chain of custody, or correlation event between the time of issue and receipt depends on the collection of information from manual processes (such as physical signature capture or bar code scanning) and compilation of information from multiple sources, making it very difficult, if not impossible, to gather real or near real time information of end to end package or envelope delivery processes. Therefore, there is a desire to know when an actual addressee has received a letter, parcel, package or the like.

### SUMMARY OF THE INVENTION

The preferred embodiment of the invention includes a method for verifying receipt of a postal mail item mailed by a sender of the postal mail item. The method reads postal information from a postal mail item that identifies the postal mail item. The postal information is combined with identification information that identifies the recipient of the postal mail item. Then the postal information and the identification information are sent to the sender of the postal mail item.

The preferred embodiment can include detecting the location and status of packages or envelopes, and automatically detecting when a package or envelope has been opened, by means of an intelligent package or envelope described herein, using software logic stored in a micro-chip incorporated into the package or envelope, and a smartphone, tablet PC, personal computer, printer, or similar reading device that can transmit the status and location of the package or envelope to a cloud based infrastructure, application and data store. Specifically, the method relates to the ability to detect the status and location of packages or envelopes with a view to monitoring service performance, reducing fraud, collecting meaningful analytical information, providing confirmation of receipt, and triggering automatic actions based on pre-programmed logic or pre-configured parameters.

The preferred embodiment of the invention overcomes at least some of the drawbacks relating to the process of establishing the location, routing, actual time and location of receipt and opening of a package, envelope or the like.

Another configuration of the preferred embodiment establishes the identity of the person opening the package or envelope, by means of a device virtually every human being carries or will soon carry: a smartphone, tablet PC or other wireless device, with the ability to securely establish the user's identity, as well as the location of the device using GPS or other available triangulation methods.

Another configuration of the preferred embodiment, provides automated methods to analyze processes related to the delivery, receipt and opening of the package or envelope, providing critical business intelligence and analytics information that can help improve processes, streamline operations, automatically trigger billing based on timely delivery, etc.

Yet another configuration of the preferred embodiment is to provide a method to automatically identify instances of potential fraud, unlawful rerouting or intentional delays in the delivery of packages or envelopes, by means of automated alarms and notifications triggered by events outside of norm, as detected by either location/ID/date/time scans outside of an established norm, or lack of reporting within pre-established parameters.

In one configuration of the preferred embodiment, the method uses a cellular phone to read postal information from the postal mail item. The identification information can be associated with a cellular telephone and can be a cellular phone number associated with the owner of the cellular phone.

In another configuration of the preferred embodiment, the reading information about the postal mail item includes reading the information about the postal mail item with a mobile telephone using near field communications (NFC). The information about the postal mail item is read from an RFID attached to the postal item. The information about the postal item may be read automatically or it must be initiated. For example, the mobile telephone can be configured or set up to automatically read the RFID and to automatically transmit information is combined with identification information that identifies the recipient back to the sender of the postal mail item. In a manual configuration, the owner of the mobile telephone would need to initiate that the mobile phone read the RFID and/or to initial the sending of a message back to the sender of the postal mail item.

Yet another configuration of the preferred embodiment includes activating an RFID in the postal mail item so that the RFID can be read. The activating of the RFID can be performed by a wireless device.

Another configuration of the preferred embodiment is a system for verifying receipt of a postal item that was mailed by a sender of the postal mail item. The system includes a read logic, an identification logic and a communications logic. The read logic reads information associated with a postal item from the postal item. In one configuration, the read logic can read the information associated with the postal item from an RFID tag associated with the postal item. The identification logic is configured to identify a person receiving the postal item as the recipient person. In one configuration, the identification logic can identify the person receiving the postal item by determining a telephone number associated with the person. The communication logic communicates to the sender that the postal item has been received by the recipient person.

In another configuration of this system, the read logic is configured to wirelessly read the information associated with the postal item. The identification logic can retrieve a digital identification associated with the person receiving the postal item and the communication logic transmits the digital identification to the sender of the postal item. The read logic, identification logic and communication logic can be integrated into a cellular telephone.

One objective of the invention is to overcome at least some of the drawbacks relating to the process of establishing the location, routing, actual time and location of receipt, and opening of a package or envelope.

Another objective of the invention is to establish the identity of the person opening the package or envelope by means of a device virtually every human being carries or will soon carry: a smart-phone, tablet PC or similar wireless device, with the ability to securely establish the user's identity, as well as the location of the device using GPS or other available triangulation methods.

Yet another objective of the invention is to provide automated methods to analyze processes related to the delivery, receipt and opening of the package or envelope, to provide critical business intelligence and analytics information that can help improve processes, streamline operations, automatically trigger billing based on timely delivery, etc.

Still yet another objective of the invention is to provide a method to automatically identify instances of potential fraud, unlawful re-routing or intentional delays in the delivery of packages or envelopes by means of automated alarms and notifications triggered by events outside of norm, as detected by either location/ID/date/time scans outside of an established norm, or lack of reporting within pre-established parameters.

Another configuration is a method of detecting when a package or envelope has been delivered to the intended addressee. The method begins by the addressee activating the built in RFID device on the package or envelope by placing an NFC enabled device near the package or envelope. The built in RFID device then detects whether the package or envelope has been opened by means of built in logic that changes the status of a flag from 0 (not open, all circuits connected) to 1 (opened, at least one circuit shorted) when one of the multiple circuits within the package or envelope has been cut. The NFC enabled device, using a previously downloaded application, receives the unique ID of the package or envelope together with the status flag set to 0 or 1. When the package has already been opened, the NFC can then send a message indicating this to a sender of the package. The location of the package can also be sent in that message.

Another configuration is a method of reporting to a cloud based data store that the package or envelope has been scanned and the status and location of such. An NFC enabled device automatically transmits a data set using one of multiple available transmission methods (i.e., 3G or 4G wireless data, WiFi, short message system, text messaging, etc.). The data set can include a user ID (previously established when the device user activated the device), a package or envelope unique ID obtained from the built in RFID device, an open/unopened status flag received from the RFID device, the location of the reading device, and date and time of transmission.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of a system for verifying receipt of a postal item that was mailed by a sender of the postal item.

FIG. 2 illustrates an embodiment of a reader that can read data from the postal item.

FIG. 3 illustrates an embodiment of a method for verifying receipt of a postal item that was mailed by a sender of the postal item.

FIG. 4 illustrates another architectural diagram of a system 400 for tracking postal items that is similar to FIG. 1 but includes a few different details.

FIG. 5 illustrates an example envelope with an interior conductive inlay attached to an RF-powered microchip and antenna.

FIG. 6 illustrates another example envelope with an interior conductive inlay attached to an RF-powered microchip and antenna.

FIG. 7 illustrates and example battery and a printed circuit board constructed on an envelope using printed battery and circuit board technology.

Similar numbers refer to similar parts throughout the drawings.

### DETAILED DESCRIPTION

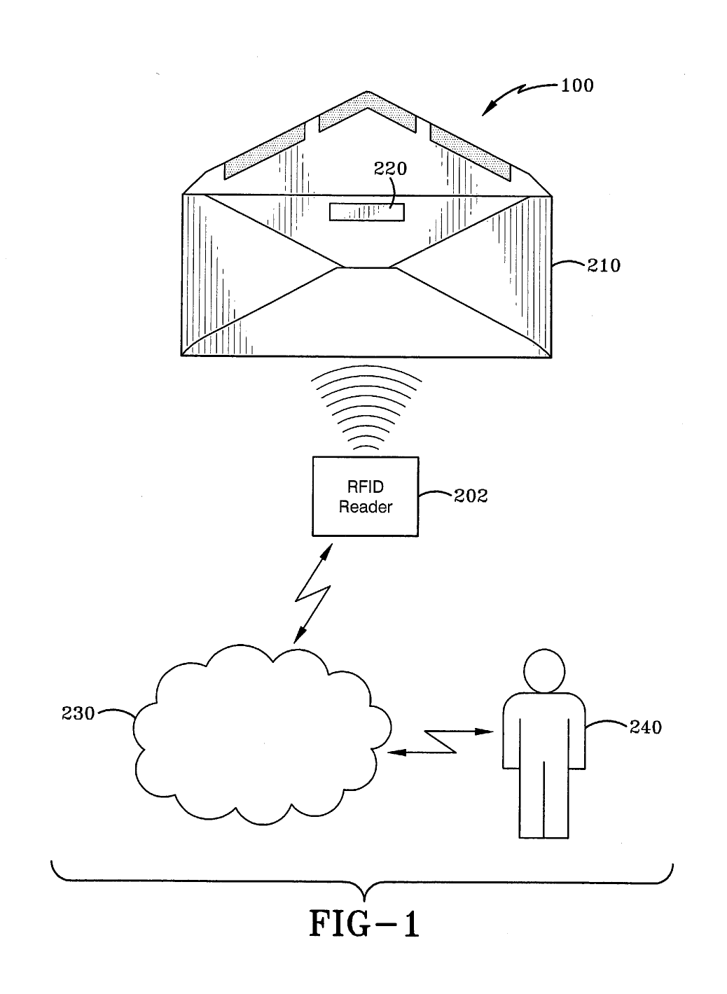

FIG. 1 illustrates the preferred embodiment of a system 100 for verifying receipt of a postal item 210 that was mailed by a sender 240 of the postal item 210. In the preferred embodiment, a person 240 or business mailing a postal item such as a letter 210, package, parcel or the like would attach a radio frequency identification (RFID) tag 220 to the mail item 210 while packaging the item 210. In this specification the term parcel includes all packing used to send items through the mail including envelops, boxes, folders and the like. The RFID tag would be written (programmed) with data associated with the sender 240 of the letter such as the sender's email address, telephone number, the date the letter 210 was mailed and the like. The letter 210 eventually reaches its destination recipient.

When the letter 210 is received a reader 202 will read the RFID tag 220 to extract the information about the sender 240 and the letter 210. The reader 202 can be an RFID reader. The reader 202 can be set up and configured to automatically read the RFID tag 220 or it can be configured to wait until the recipient of the letter 210 prompts the reader 202 to read the RFID tag 220. The RFID tag 220 can be self-activated and require very little energy to activate or can be activated by a small battery attached to the RFID tag 220. The RFID tag 220 can be activated by using a small amount of energy supplied by a near field communication (NFC) device that is located in a device such as a cell phone.

After the reader 202 has read the RFID tag 220, information about the sender is known allowing the reader 202 to then generate a message reporting the time that the letter was received back to the sender 240. For example, the reader 202 may be a NFC device located in the cellular phone of the recipient and the reader 202 can read the RFID tag 220 and transmit a text message into a network 230 or network cloud for transmission to the sender 240 or a database managed by the sender. Again, the reader 202 can be set up to automatically generate and transmit this message or it can be configured to wait until it is prompted to read the RFID tag 220 and/or also prompted to send this message.

The system of verifying receipt of a postal item 100 shown in FIG. 1 provides a low cost way for the sender to actually know that a postal item has been received by a recipient. Certain products are time sensitive and require a sender to know whether the recipient has received the postal item 210 or not and also the time it was received. In general, medicine/prescriptions and credit cards are often time sensitive and of such a value that their sender desires to know when these products arrive at the recipient that they were intended for. In the case of medicine, the patient may run out of medicine and could die if their medicine supply ran too low and eventually was exhausted.

FIG. 2 illustrates logic that can be included in the reader 202 of FIG. 1. The reader 202 includes read logic 102, identification logic 104 and communication logic 106. “Logic,” as used herein, includes but is not limited to hardware, firmware, software and/or combinations of each to perform a function(s) or an action(s), and/or to cause a function or action from another logic, method, and/or system. For example, based on a desired application or need, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

In the preferred embodiment, the read logic 102 reads information associated with a postal item from the postal item. As previously mentioned, the read logic 102 can be a NFC RFID reading type of device implemented in a smart-phone that reads RFID tags. The read logic 102 can also be implemented in a tablet computer, iPhone, Blackberry, Android and other types of electronic devices. Also, as mentioned earlier, the read logic can be configured to automatically read the read information associated with the postal item or it can be configured to wait for a prompt before beginning that reading.

The identification logic 104 identifies the person receiving the postal item as the recipient person. For example, when the read logic 102 is implemented in a cellular phone, logic in the phone can extract a phone number identifying the owner of the phone. The communication logic 106 can then generate a message indicating the post item has arrived and transmit that message back to its sender along with the telephone number of the recipient, time of arrival and other information.

In one configuration of the preferred embodiment, the sender can write a phone number of the intended recipient of the mail item 210 into the RFID tag 220. The read logic 102 can then read (either automatically or when prompted) that phone number out of the RFID tag 220 when the mail item is received by the recipient. The identification logic 104 extracts a phone number that belongs to a person receiving the mail item 210 out of an electronic device such as cell phone that is carried by the recipient. The identification logic 104 then compares the phone number of the recipient to the phone number extracted from the RFID tag. If the two numbers match, the indented recipient received the mail item 210 and the communication logic 106 sends a message indicating this is sent to the sender 240 of the mail item 210. If the phone numbers do not match then the intended recipient did not actually receive the mail item 210 and the communication logic 106 sends a message indicating this is sent to the sender 240 of the mail item 210. Again, this sending can be automatic by the communication logic 106 or the communication logic 106 can be configured to require prompting to send this message. Alternatively, the system 100 may generate an alarm indicating this to the sender 240 or other personnel.

In another configuration of the preferred embodiment, the RFID tag 220 can periodically be read by various RFID readers along its route of travel and at each location it is read, it can be sent data about that location, time at that location, and other data to a database specified on the RFID tag 220 by the sender. When the mail item 210 has taken too long to reach its recipient or has deviated from a desired route of travel, this periodic location information can be extracted from the database and its route of travel reconstructed in an effort to locate the mail item 210. Alternatively, attempts can be made to locate the mail item 210 by triangulating the RFID tag 220 or using a GPS system to locate the RFID tag 220. In one configuration of the preferred embodiment, an automatic detection can be made that the mail item 210 has been opened and a reply message to the sender of the mail item 210 will automatically be generated and sent.

Another configuration of the preferred embodiment can be used to alert the sender of possible opening of the mail item 210 before it reaches the recipient. Conductive tape, conductive ink, printed ink or another conductive material can be deposited inside the mail item 210 so that conductive path(s) can be wrapped around the inside of the mail item 210 in a way that the mail item 210 cannot be opened without breaking the conductive path(s). When the conductive path(s) is cut, a status flag is set to indicate the mail item 210 was opened. The read logic 102 can read this status flag and the communication logic 106 can send an indication to the sender of the postal item 210 that it was opened before it reached the recipient when the status flag is set.

If the recipient of the mail item 210 does not confirm by the cell phone the receipt or does not use a cellular phone to confirm receipt then, the sender would know that the recipient is not the same person to whom the mail item 210 was addressed. Knowing this information allows a follow up contact to be made from the sender to the real recipient of the mail item 210 informing that the mail item 210 has not been opened by the real recipient. This also helps sender follow up the mail item 210 to prevent fraud in cases such as credit cards sent by mail.

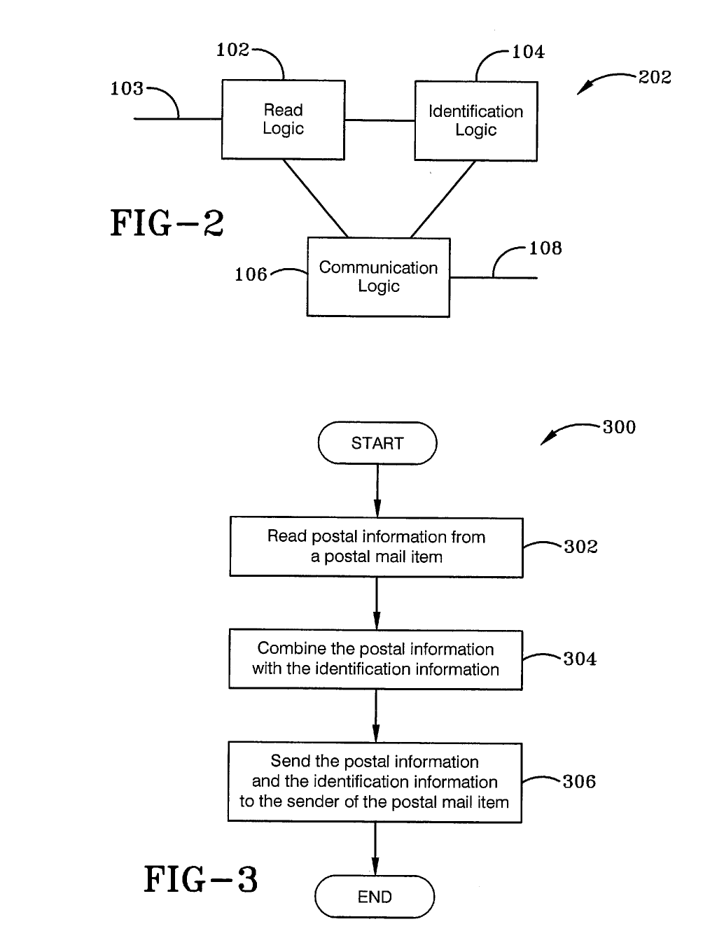

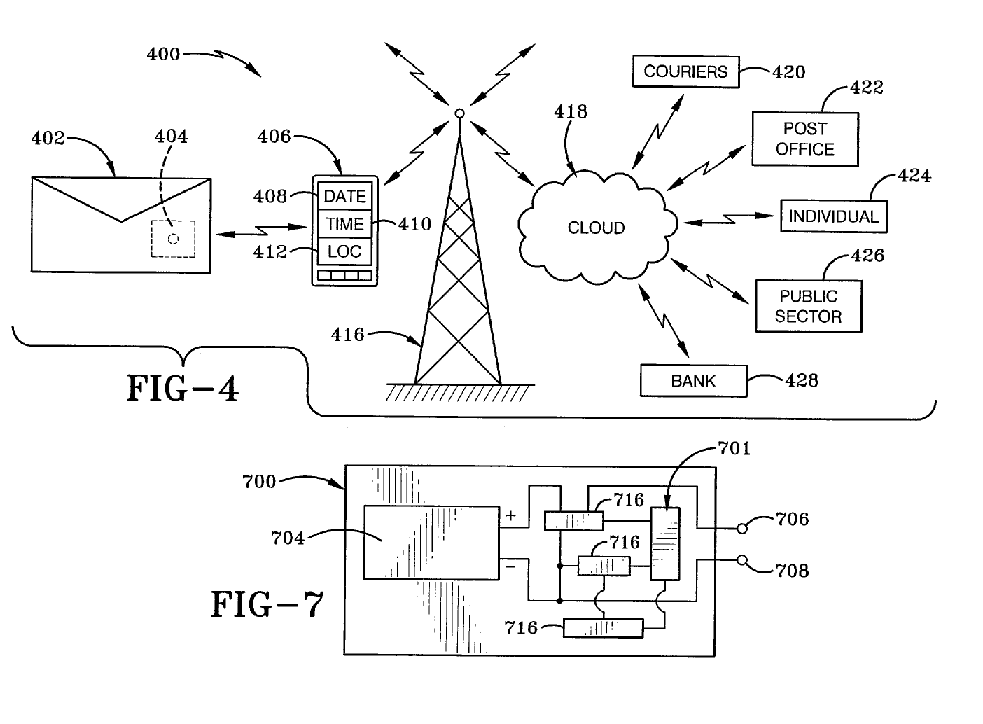

FIGS. 4-7 provide further details of FIGS. 1 and 2 will first be discussed before discussing FIG. 3 that illustrates an example method for tracking a postal item. FIG. 4 illustrates another architectural diagram of a system 400 for tracking postal items that is similar to FIG. 1 but includes a few different details. The system 400 includes an RFID enabled envelope 402 or package. The RFID enabled envelope 402 can already be implemented with an RFID 404 or the RFID tag 404 can be attached to the envelope 402 at the time it is used. A smart phone 406 with NFC capabilities is used to scan the envelope 402 to read an ID and a flag from the RFID tag 404. For example, a flag value of zero “0” indicates that the envelope is sealed and not opened since it has been sealed. The NFC capable smartphone 406 can be any NFC capable smartphone such as a BlackBerry Bold 9900, BlackBerry Bold 9930, iPhone 5, Android Gingerbread 2.3.3, Motorola L7, Samsung Galaxy S II, Nokia 6131, or another kind of smartphone.

The NFC smartphone 406 can also determine a date 408 the envelope was sent, a time 410 it was sent and a location 412 from which it was sent. These values can be stored in the NFC capable smartphone 406 and are also sent to an intended recipient of the envelope 402 along with the ID and the flag read from the RFID tag 404. This data is transmitted to a currier 416. For example, the currier 416 can be a wireless network or a WiFi that uses cellular antennas to receive and transmit this data. The currier 416 will eventually transmit this data into a network cloud 418. From the network cloud 418 it is then routed to the intended recipient of the letter 402. For example, the data can be routed to other couriers 420, a post office 422, an individual 424, a public sector network 426, a bank 428 and the like.

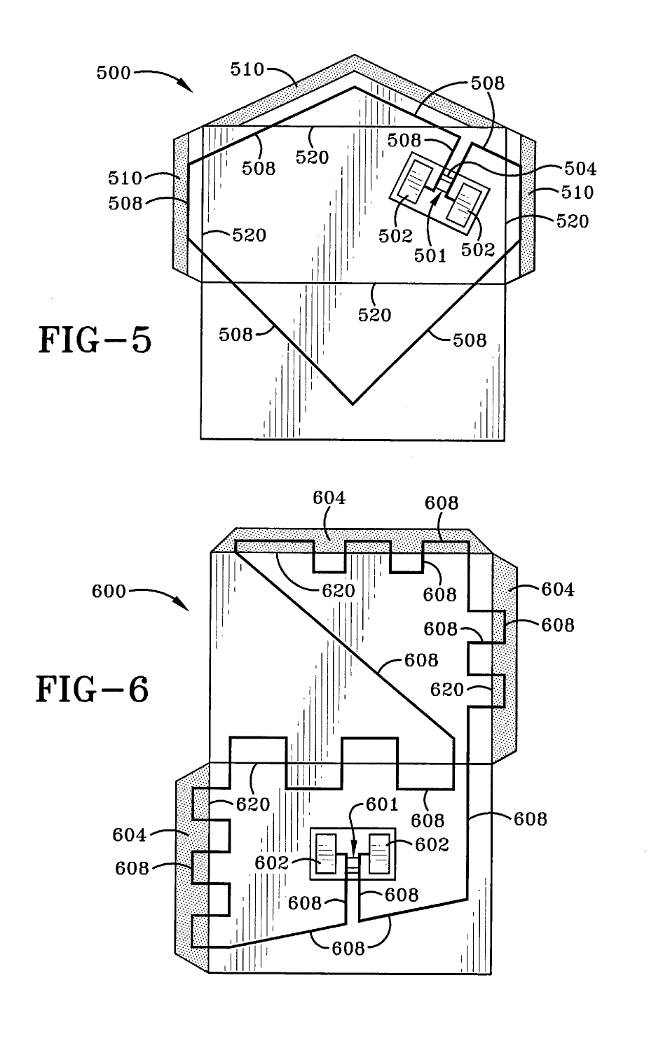

FIG. 5 illustrates an example envelope with an interior conductive inlay attached to an RF-powered microchip and antenna. This Figure illustrates a envelope 500 in an unfolded state. However, the envelope 500 could be pre-folded and glued at its edges. When the envelope 500 is not pre-folded and glued, it can be folded as indicated by the fold lines 520 in FIG. 5. Glue areas 510 are located at various edges of the envelope to allow the envelope to be folded and then securely glued. The envelope 500 can be a #10 envelope or another size envelope.

A radio frequency (RF) powered RFID chip 501 that has antennas 502 and is located inside the envelope 500. The RFID chip also stores a flag 504 in it that indicates if the envelope 500 has been opened. When the envelope 500 is sealed up and the RFID chip 502 is activated and the flag is set to zero “0” and remains that value as long as an interior inlay line 508 is not open when the RFID tag is later read. If the interior inlay line 508 is open (broken) then the flag value would become a value of one “1” and the unauthorized opening of the envelope 500 can be discovered. The interior inlay line 508 can be formed out of any suitable conductive material such as thermoset conductive ink, copper alloy, silver, gold, aluminum etch and the like.

FIG. 6 illustrates another example envelope 600 that has an RFID chip 601 that is configured to communicate using antennas 602. The envelope 600 shown in FIG. 6 is shown in an un-folded state and is similar to a 9×12 inch envelope but it can be other sizes and shapes. Portions of the envelope 600 can be folded at the indicated fold lines and glue areas 604 can be used to seal the envelope 600. Similar to the envelope 500 of FIG. 5, an interior inlay line 608 can be routed throughout the envelope 600 so that it is very difficult to open the envelope without opening (breaking) the interior inlay line 608. The interior inlay line 608 is electrically connected to the RFID tag 601 and if the interior inlay line 608 is broken this information can be communicated to the sender and/or recipient of the envelope 600 or to another person or entity.

Another configuration of the preferred embodiment takes advantage of some recent advanced steps toward fabricating circuit boards with inkjet printers by synthesizing tin (Sn) nanoparticles and then adding the nanoparticles to ink to increase its conductivity, leading to improved ways to print circuit boards. Fabricating circuit boards using inkjet printing technology can overcome limitations of current circuit board fabricating and create a faster, simpler and less expensive way to produce a variety of devices, such as RFID tags, LEDs, organic solar cells, organic thin film transistors, and biomedical devices. This technology can be used to fabricate producing intelligent envelopes and packages.

FIG. 7 illustrates an example printed circuit board 700 that includes a printed RFID 701 that is similar to the RFID chips discussed above and a printed battery 704. The printed circuit board can be printed onto an envelope using inkjet technology as discussed above. Other electronic components 716 used to bias and/or power the printed RFID or to control it in other ways can also be created in a similar way on the envelope. Terminal ends 706, 708 of the of the printed circuit board 700 are attached to an interior inlay line similar to the interior inlay lines 508 and 608 of FIGS. 5 and 6, respectively, as discussed above. The printed battery 704 can be a thin film battery that is about 1 mm thick and is non-rechargeable, can have a long life and operate at any practical voltage. For example, it can operate anywhere from about three volts up to about 48 volts.

An envelope, box or another type container used to transport items through the mail that uses an active or semi active devices similar to the printed circuit board 700 of FIG. 7 could automatically transmit information to an NFC enabled receiving device that it is being opened at the time it is opened. This information could then be transmitted to a network cloud or some other network and then delivered to the sender of the parcel, the intended receiver of the parcel or another entity interested in the proper reception of that parcel.

As mentioned earlier, one or more actions performed by hardware can also be performed by software. A computer program that includes computer readable software instructions can be located in the RFID chip. The computer readable software instructions can include software instructions capable of detecting if one or more of the circuits has been cut as a result of someone opening the package or envelope. These instructions can execute when activated by means of an RF signal sent by the NFC enabled device. Other software instructions can automatically compiling a message containing a package or envelop unique ID and the status of the package of envelope (opened or closed). Other software instructions cause the transmitting the message created to the NFC enabled device with other instructions implementing error detection and correction capabilities, with corresponding re transmission functionality.

In other application a computer program includes computer readable software instructions that can operate on multiple operating systems (BlackBerry OS, QNX, iPhone, Android, WebOS and the like). The computer readable software instructions include software instructions capable of activating the package or envelope built in RFID device and receiving the data stream sent back by such RFID device. Other instructions are capable of determining the status of the package or envelope (i.e. opened, or not yet opened). The instructions can include depending on the determined status of the RFID device, automatically compiling a message containing the user ID of the NFC enabled device, the status of the package of envelope (opened or closed), the location of the device using GPS or other available real time triangulation method, and/or the date and time of the event. Software instructions can also be capable of transmitting the message created to a cloud based data store using one or more of the device's available data transmission capabilities. Other instructions can have error detection and correction capabilities, with corresponding retransmission functionality.

Another embodiment includes a computer program or programs comprising computer readable software instructions for receiving transmissions from multiple NFC enabled devices, data storage and retrieval, data analytics and reporting. The computer readable software instructions include software instructions designed to operate in a cloud based environment, with multitenant, automated orchestration, security and privacy protection, elastic provisioning and secure data storage. Other software instructions are capable of identifying, authenticating and accepting data packets from a remote NFC enabled device. Some software instructions are capable of comparing the unique ID of each package or envelope scanned by the NFC enabled device against a corresponding authentication platform (i.e., a post office data store containing the unique IDs of packages or envelopes sent to a recipient, the addressee's information and other pertinent information) using Web Services following a Services Oriented Architecture (SOA) methodology. Some Software instructions are capable of reporting the location and status of the package or envelope and storing such information in a secure data store for later access. Software instructions can be capable of triggering diverse actions depending on detected situations in accordance with user configurable parameters, including: (1) automatically submitting a notification message to a third party recipient, or to the original addressee in the case the package or envelope has been detected at a location it ought not to be at, or in the case the package or envelope has been opened by someone other than the intended addressee, (2) automatically submitting a confirmation of receipt message to the originator, (3) automatically sending a message to the NFC enabled device with appropriate instructions or warnings. Other software instructions are capable of creating reports or analytical compilations based on a variety of parameters, including: (1) date and time of delivery and opening of the package or envelope (2) actual versus estimated correlation of elapsed time from package sending to receiving (3) analysis of reported instances of package or envelope scanning and reporting (4) actual routing of packages or envelopes, as reported by scanning stations strategically located along the package delivery process. Other instructions have functionality for secure access, encryption, role based access control, privacy protection, abnormal human or system action reporting, data backup and other best practices for overall system and process security and governance.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 3 illustrates a method 300 of verifying receipt of a postal mail item mailed by a sender of the postal mail item. The method 300 begins by reading postal information, at 302, from a postal mail item that identifies the postal mail item. As previously discussed, the reader may be an RFID reader for reading information about the postal mail item from an RFID tag attached to the postal mail item. The reader may be an RFID reader located in a cellular telephone. The reading the information, at 302, can be performed utilizing a near field communication (NFC) environment generated by the mobile telephone.

The postal information is combined with identification information, at 304. The identification information identifies the recipient of the postal mail item. Also, as previously mentioned, the identification information can be a cellular telephone number of the recipient of the postal mail item. The postal information and the identification information is sent to the sender of the postal mail item to allow the sender to know that the person intended to receive the postal mail item has received it. Again the reading and sending can be automatic or a device performing the reading and sending can be configured to first wait for a read prompt and/or a send prompt before performing the reading and/or sending.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Repeated use of the phrase “in the preferred embodiment” does not necessarily refer to the same embodiment, though it may.

What is claimed is:

1. A method of automatically detecting when a parcel has been properly delivered to a recipient comprising:
detecting whether a conductive material inside the parcel has been opened or not;
with an electronic device external to the parcel, energizing a communication device located in the parcel;
upon the communication device becoming energized, transmitting from the communication device to the electronic device external to the parcel a signal that identifies if the conductive material in the parcel has been opened or not.

2. The method of automatically detecting when a parcel has been properly delivered to a recipient of claim 1 wherein the detecting that a conductive material inside the parcel has been opened further comprises:
detecting whether the conductive material has been opened with logic located on a radio frequency identification (RFID) chip and wherein the energizing a communication device located in the parcel further comprises:
energizing the RFID chip and wherein the transmitting from the communication device further comprises:
transmitting from the RFID chip.

3. The method of automatically detecting when a parcel has been properly delivered to a recipient of claim 2 wherein the detecting that a conductive material inside the parcel has been opened further comprises:
detecting that an interior inlay line that is conductive has been opened, wherein the interior inlay line is routed around the interior of the parcel so that the parcel essentially cannot be opened without breaking the interior inlay line.

4. The method of automatically detecting when a parcel has been properly delivered to a recipient of claim 3 wherein the detecting that a conductive material inside the parcel has been opened further comprises:
detecting that an electrical path of the interior inlay line has been opened.

5. The method of automatically detecting when a parcel has been properly delivered to a recipient of claim 4 further comprising:
when the electrical path of the interior inlay line has been opened, changing a flag value stored in the RFID tag from zero (“0”) to one (“1”); and wherein the transmitting from the RFID chip to the electronic device external to the parcel the signal that identifies if the interior inlay line in the parcel has been opened or not further comprises:
transmitting from the RFID chip to the electronic device external to the parcel the flag value.

6. The method of automatically detecting when a parcel has been properly delivered to a recipient of claim 4 wherein the detecting that an electrical path of the interior inlay line has been opened further comprises:
detecting that an electrical path formed by one of the group of: a thermoset conductive ink, a copper alloy, silver, gold and an aluminum etch has been opened.

7. The method of automatically detecting when a parcel has been properly delivered to a recipient of claim 2 wherein the upon the communication device becoming energized further comprises:
energizing the RFID chip with a near field communication (NFC) device.

8. The method of automatically detecting when a parcel has been properly delivered to a recipient of claim 2 wherein the detecting whether the conductive material has been opened further comprises:
generating very low voltage (VLV) signal from the RFID chip and along an interior perimeter of the conductive material; and
identifying with the logic in the RFID chip when the conductive material has been broken as a result of the parcel having been opened.

9. The method of automatically detecting when a parcel has been properly delivered to a recipient of claim 2 wherein the transmitting from the communication device to the electronic device external to the parcel a signal further comprises:
creating a message that includes an identification number of the RFID tag and an indication for indicating if the parcel was opened or not before reaching an intended recipient; and
transmitting the message to a NFC device.

10. The method of automatically detecting when a parcel has been properly delivered to a recipient of claim 9 further comprising:
detecting that the message was not properly received by the NFC device; and
retransmitting the message to the NFC device upon detecting that the message was not properly received by the NFC device.

11. The method of automatically detecting when a parcel has been properly delivered to a recipient of claim 10 further comprising:
automatically submitting a notification message to a third party recipient and original sender of the parcel or to the intended recipient in the case the package or envelope has been detected at a location it ought not to be at, or in the case the package or envelope has been opened before it was received by the intended recipient.

12. A system for verifying that a mail item is to be received by an intended recipient of the mail item comprising:
an interior inlay routed on the inside of the mail item so that one is essentially unable to open the mail item without opening or breaking the interior inlay;
detection logic configured to detect that the interior inlay line of the mail item was either opened or unopened after the mail item was sealed and mail to the intended recipient;
communication logic to communicate to the intended recipient of the mail item that the interior inlay line of the mail item has been opened or unopened.

13. A system for verifying that a mail item is to be received by an intended recipient of the mail item of claim 12 wherein the detection logic configured to detect that the interior inlay line of the mail item was either opened or unopened by detecting that an electrical path of the interior inlay line has been opened.

14. A system for verifying that a mail item was received by an intended recipient of the mail item of claim 12 wherein the interior inlay line is formed by one of the group of: a thermoset conductive ink, a copper alloy, silver, gold and an aluminum etch.

15. A system for verifying that a mail item is to be received by an intended recipient of the mail item of claim 12 wherein the communication logic is configured to communicate to a sender of the mail item that the interior inlay line of the mail item has been opened or unopened.

16. A system for verifying that a mail item is to be received by an intended recipient of the mail item of claim 12 wherein the detection logic is configured to set a flag in the detection logic to indicate that the interior inlay line of the mail item has been opened or unopened when detecting that the interior inlay line of the mail item was either opened or unopened after the mail item was sealed and mailed to the intended recipient.

17. A system for verifying that a mail item is to be received by an intended recipient of the mail item comprising:
location logic configure to determine a location of the mail item, wherein the communication logic is configured to communicate the location of the mail item to a sender of the mail item.

18. A system for verifying that a mail item is to be received by an intended recipient of the mail item of claim 12 further comprising wherein the communication logic is further configured to read identifying information from a device associated with the recipient of the mail item and to mail the identifying information to the sender of the mail item.

19. A system for verifying that a mail item is to be received by an intended recipient of the mail item of claim 12 wherein the detection logic is configured to be powered by an electromagnetic of a near-field communication (NFC) device.

20. A system for verifying that a mail item is to be received by an intended recipient of the mail item of claim 12 wherein the detection logic is implemented in an radio frequency identification (RFID) chip.
